(19) United States
(12) Patent Application Publication
(10) Pub. No.: US 2007/0279635 A1
(43) Pub. Date: Dec. 6, 2007

(54) Measuring apparatus and method using surface plasmon resonance

(75) Inventors: Pao Tung Wu, Jhubei City (TW); Chien Ming Wu, Hsinchu City (TW)

Correspondence Address: John S. Egbert;Egbert Law Offices, 7th Floor, 412 Main Street, Houston, TX, 77002, US

(73) Assignee: NATIONAL TSING HUA UNIVERSITY, Hsinchu (TW)

(21) Appl. No.: 11/491,598

(22) Filed: Jul. 24, 2006

(30) Foreign Application Priority Data
May 30, 2006 (TW) 095119115

(51) Int. Cl. G01N 21/55

(52) U.S. Cl. 356/445

(57) ABSTRACT

An apparatus and a method for measuring gap width, displacement shift or relative position between two subjects using surface plasmon resonance (SPR) are disclosed. First, a TM mode light beam is provided, so as to generate SPR on a surface of one of the two subjects. Then, the signal of the reflective light or penetrative light on the surface is measured. Because SPR is sensitive to the changes of the gap, displacement shift or relative position when the width of the gap is equal to or smaller than twice the penetration length of the surface plasmon wave, the gap, displacement shift and relative position can be acquired by sensing changes of the signal. Accordingly, the width of the gap, displacement shift, relative position and surface roughness smaller than twice the penetration length or even less than 10 nm can be measured.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to an apparatus and a method for measuring small gap width, displacement shift, or relative position by means of surface plasmon resonance (SPR). More particularly, the present invention relates to an apparatus and a method for measuring nanometer-scale gap width, displacement shift, or relative position by SPR.

### BACKGROUND OF THE INVENTION

For a long time, optical measuring methods in the science field mainly use optical interference measuring techniques. By analyzing some changes of interference fringes, the displacement shift of the relative subject can be calculated, and with more precise measuring apparatus, smaller changes of displacement shift can be detected. However, there has been no breakthrough in the development of the method for measuring gap width of nanometer scale. The reason for this is that the optical interference method for measuring small gap has no interference fringe when the gap width is less than half of the wavelength. Therefore, the measuring method using normal visible light is not applicable for gap widths less than 300 nm, 100 nm, or 10 nm.

A research group at Massachusetts Institute of Technology (MIT) used the so-called “chirped-Talbot effect” to measure gaps of nanometer scale, and indicated that the sensitivity of this method can be less than 1 nm. However, the measurable range is from about 30 μm to about 1 μm. Accordingly, in order to overcome the interference limit that the measurable gap width cannot be less than half of the wavelength in optical methods, the present invention discloses a method for measuring a gap width of nanometer scale, displacement shift, and a relative position between two subjects by means of SPR.

The so-called SPR phenomenon is the collective oscillation of metal surface electrons. After the transverse magnetic (TM) mode light parallel to the incident plane is coupled through a prism or other components, if one surface of the prism is plated with a metal film, e.g., gold or silver film, a surface plasmon wave is generated on the surface of the metal film. When the wave vector of the incident light is equal to the wave vector of the surface plasmon wave of the medium material containing the metal film interface, resonance will occur. At this time, the incident light transfers energy to the interface where the SPR occurs, such that the intensity of the reflected light (also called the reflectivity) decreases dramatically, as shown in FIG. 1. The occurrence of SPR is characterized in that when the incident light meets the requirements of SPR, the resonance angle B, e.g., 44 degrees, is a specific angle greater than the critical total reflection angle A. In addition, most or even almost all of the energy of the incident light is absorbed, and thus the intensity of the reflected light (or reflectivity) at the resonance angle B is the lowest, and can theoretically be reduced to zero.

The wave vector of the incident light is expressed by Equation (1) and the wave vector of the surface plasmon wave is expressed by Equation (2). If the vectors are equal, the wave vectors match and SPR occurs to transfer the energy of the incident light to the surface plasmon wave. Actually, SPR occurs only under specific conditions (for example, a specific incident angle or specific wavelength). The wave vector of the incident light is expressed by

kₓ=k₀nₚ sin θ (1)

where kₓ is the wave vector component of the incident light parallel to the metal and prism interface, k₀ is the wave vector in the vacuum K₀=ω/c=2π/λ, ω is the angle frequency, c is the velocity of light, λ is the wavelength of the incident light, θ is the incident angle of light, and nₚ is the refractive index of the prism. The surface plasmon vector kₛₚ is expressed by

$${k}_{sp} = {k}_{0} \sqrt{\frac{{ɛ}_{m} {ɛ}_{d}}{{ɛ}_{m} + {ɛ}_{d}}} \qquad ( 2 )$$

where εₘ and ε_{d} are the dielectric coefficient of the metal and the dielectric coefficient of the subject to be measured, respectively, and ε_{d}=n_{d}², and n_{d} is the refractive index of the subject to be measured.

When the wave vectors of the incident light and the surface plasmon wave satisfy the condition of kₓ=kₛₚ, SPR occurs. If any parameter in Equation (2) has minor changes, for example, the refractive index changes, the resonance conditions will be not met, and the energy coupling of the incident light and the surface plasmon wave changes again. Therefore, the SPR can be used to measure small changes of physical or chemical characteristics of the subject to be measured.

Basically, three modes of incident light coupling can cause SPR, including grating coupling, optical waveguide coupling, and prism coupling. Prism coupling usually occurs with attenuated total internal reflection (ATR) in measurement of reflectivity. As this method is simple and convenient, it has become the most popular method applied in SPR measurement apparatuses. According to different configurations of basic components, prism coupling can be classified into a K.R. configuration or an Otto configuration. The main difference between the two configurations is that the K.R. configuration has a metal thin film layer plated on the bottom of the prism, whereas the Otto configuration has a prism disposed above a panel plated with a metal thin film layer on the surface thereof. However, regardless of the configuration or the light coupling mode changes, as long as the incident light wave vector kₓ is equal to the wave vector kₛₚ of the interface medium material, SPR will occur, which can be used in various measurement applications.

Currently, the measurement of SPR is generally classified into four modes, namely, angular interrogation measurement, wavelength interrogation measurement, intensity interrogation measurement, and phase interrogation measurement.

In the angular interrogation measurement, the incident angle of the incident light is changed, and the horizontal wave vector increases with the increase of the angle. When a certain incident angle is reached, and the horizontal wave vector of the light is equal to the SPR wave vector, the intensity of the reflected light has a minimum value, and this angle is the resonance angle of the surface plasmon wave. Then, if the refractive index of the neighboring media on the interface changes, or the refractive index, weight, or density of the subject to be measured that is attached on the interface changes, the surface plasmon wave vector will change accordingly, which further leads to the change or drift of the resonance angle. By measuring the angle drift, the changes of physical or chemical properties of the interface or the subject to be measured on the interface can be obtained.

In the wavelength interrogation measurement, the incident angle is fixed, while the wavelength of the incident light changes to perform the measurement. The wavelength of the incident light is adjusted to a specific wavelength to meet SPR requirements, and the intensity of the reflected light is reduced to a minimum value. The specific wavelength is the SPR wavelength. Then, if the refractive index of the neighboring media on the interface changes, or the refractive index, weight, or density of the subject to be measured that is attached on the interface changes, the surface plasmon wave vector changes accordingly, which further leads to the change or drift of the resonance wavelength. By measuring the wavelength drift, the changes of physical or chemical properties of the interface or the subject to be measured on the interface can be obtained.

In the intensity interrogation measurement, the physical or chemical properties of the interface change slightly, such that the SPR requirements change, and the intensity of the reflected light changes accordingly. Therefore, the changes of the physical or chemical properties of the interface can be detected by measuring the variation of the intensity of the reflected light. To achieve high sensitivity, the measurement is usually performed with a fixed angle at the position where the slope of the intensity curve of the reflected light has a maximum value.

In the phase interrogation measurement, when SPR occurs, in addition to the change of the intensity of the reflected light, the phase of the light wave of the reflected light dramatically changes as well. Therefore, the changes of the physical or chemical properties of the interface can be acquired through measurement. The phase angle has the greatest change at the resonance angle, which is the so-called “phase jump.” When the phase interrogation measurement is performed, the light incident angle is usually fixed near the resonance angle to obtain the highest sensitivity.

As the principle of the SPR is simple, and the apparatus is not complicated, scientific and industrial fields have long applied this technology in the examination of gaseous or biochemical materials. For example, Nylander and Leidberg first applied the K.R. configuration in gas and biochemical examinations in 1982, which set a foundation for the research of various microsensors. In 1992, lorgenson and Yee employed optical fibers as SPR sensors, in which thin silver films are deposited on conventional optical fibers to form the SPR sensing structure, and the wavelength interrogation measurement is used to detect the changes of the characteristics of the substance on the metal surface. In 1992, an integrated optical waveguide sensing structure of an optical interference system was applied to convert signals of chemical changes to optical signals, through which the phase change caused by the optical interference was read to detect the properties of chemical solutions.

U.S. Pat. No. 6,208,422 discloses a surface plasmon sensing apparatus 20 of Otto configuration, as shown in FIG. 2(a). The basic architecture of the apparatus is that metal thin film panels 201 and 202 capable of generating surface plasmon waves are disposed on a movable carrier 203. A piezoelectric element 204 is attached beneath the movable carrier 203, and a gap exists between a surface 206 of a prism 205 and the metal thin film panel 201. In the measurement, two incident light beams 209 and 209′ accompanying with a measuring light source 200 are used, and two light sensors 207 and 208 are used to receive the reflected light signals from the surface 206 so as to generate two light amount signals 220 and 222, wherein the light amount signal 222 passes through an amplifier 221. Then, the two light amount signals 220 and 222 are sent into a data processing unit 225 to generate a driving control signal 224. The driving control signal 224 controls a driver 223 to drive the piezoelectric element 204 to be moved up and down whereby the distance between the prism 205 and the metal film panel 201 can be controlled. However, the structure of the surface plasmon sensing apparatus 20 of Otto configuration is complicated, and two incident light beams 209 and 209′ together with two light sensors 207 and 208 are required to perform the measurement. Therefore, the operation is inconvenient, and the stability is reduced due to the complicated structure.

In addition, Japan Pat. No. JP6265336 discloses a precise distance control apparatus 21 using SPR effect of Otto configuration, as shown in FIG. 2(b). The precise distance control apparatus 21 comprises a prism 210, a neutral density filter 211, a cylindrical lens 212, a photodiode array 213, a condensing lens 214, an aperture 215, a beam expander 216, a polarizer 217, a monochromatic laser light source 218, a dielectric thin film 219, a lens support 230, a piezoelectric crystal 231, and a platform 232. The operative principle of the apparatus is that a light beam generated by the monochromatic laser light source 218 sequentially passes through the polarizer 217, the beam expander 216, the aperture 215, and the condensing lens 214, and reach the prism 210, so as to generate SPR. Then, a reflected light beam is generated, which sequentially passes through the neutral density filter 211 and the cylindrical lens 212, and then is received and detected by the photodiode array 213 so as to measure the resonance angle. Furthermore, the condition of SPR will be transmitted to the piezoelectric crystal 231 through the dielectric thin film 219 and the lens support 230 (a conductive material). Afterwards, the piezoelectric crystal 231 and the photodiode array 213 control the horizontal direction of the platform 232 through a data processing unit (not shown in FIG. 2(b)), whereby the distance between two subjects can be controlled precisely. However, the Japanese patent is limited to the application of SPR of Otto configuration, and does not illustrate the relation between the corresponding changes of the resonance angle and the gap. Also, the patent is only for controlling the distance between two subjects near the position of the resonance angle, so it is not applicable to measure gap width or displacement shift of two subjects.

### BRIEF SUMMARY OF THE INVENTION

The objective of the present invention is to provide an apparatus and a method for measuring geometrical values of gap width, displacement shift, relative position, etc. by SPR. The present invention overcomes the shortcoming of the optical interference method, which cannot generate interference fringes when a gap is less than half the wavelength of the incident light, and therefore is especially suitable for measuring a gap of nanometer scale, displacement shift, or relative position.

The present invention uses the optical Fresnel reflection theorem to calculate the corresponding relation between the reflection coefficients of various multi-layer interfaces, and provides an equation of the change of the reflection indexes. The details thereof will be described in the embodiments below. On a basis of the K.R. configuration, the aforementioned equation of the change of reflection indexes is developed to form a complete three-dimensional computational simulation program, such that the relation between the changes of the incident angle and the reflection indexes is simulated. In the present invention, the phenomenon that the change of the resonance curve of the incident angle and the reflection index is very sensitive when the gap between two subjects is less than or equal to twice the penetration distance of the surface plasmon wave is used as a method for measuring nanometer scale gap, displacement shift, or relative position, and the corresponding measuring apparatus is developed based on this phenomenon.

The penetration depth of the surface plasmon wave η refers to the tendency of the electric field intensity of the plasmon wave of the inner surface of the medium to attenuate to e⁻¹ (e is a natural exponential) of the intensity at the interface, and η changes with the change of the wavelength of the incident light, the refractive index of the metal, the refractive index of the medium, and the interface condition, e.g., the cleanness of the interface, and may be slightly different from the theoretical value. The theoretical value is expressed by Equation (3):

$$η = \vert \frac{λ}{2 π} \sqrt{\frac{{ɛ}_{m} + {ɛ}_{d}}{{ɛ}_{d}^{2}}} \qquad ( 3 )$$

where λ is the wavelength of the incident light, εₘ and ε_{d} are the dielectric coefficient of the metal and the dielectric coefficient of the subject to be measured, respectively, and ε_{d}=n_{d}², and n_{d} is the refractive index of the subject to be measured.

To develop the measuring apparatus, the above computational stimulation first calculates the relative relation between the variation of the reflectivity and the gap. Alternatively, an actual measurement is conducted to collect data of corresponding relation between the changes of the reflectivity and the gap so as to establish, for example, a look-up table (LUT). When the small gap width of the subjects is measured, the data in the LUT corresponding to the numeral values displayed by the light sensing unit and the output unit is deemed the width of the measured small gap. Accordingly, the relative displacement shift or relative position of two subjects can be acquired by calculating the difference between the two gap widths.

In order to achieve the aforementioned objective, the present invention discloses an optical measuring apparatus using SPR effect, which comprises a lighting assembly, a light coupling unit, a light detection unit, an output unit, and a relative subject.

The lighting assembly provides an incident light beam containing TM wave. The light source of the incident light beam can be a laser light, a tungsten filament lamp, a mercury lamp, a light emitting diode (LED), synchronic radiating light, etc. The wavelength can be in the frequency band of infrared light, visible light, or ultraviolet light. And the TM wave can be generated in a manner of modulating by the use of an optical lens group or a polarizer. In order to reduce the noise of the incident light beam or adjust the percentage of the TM wave, optical components such as lenses, filters, and polarizers can be further disposed in the incident light path, which are regarded as a part of the lighting assembly.

The light coupling unit couples energy of the incident light beam to surface plasmon wave, and generates SPR when the wave vector of the incident light beam equals to the wave vector of the surface plasmon wave. The light coupling unit is substantially a prism plated with a metal thin film on the bottom surface thereof, in which the metal can be a single layer of gold, silver, or other composite metals, or can be a plurality of layers of gold, silver, other composite metals or composite materials. The total thickness of the metal thin film is not limited, as long as it can activate the surface plasmon wave to penetrate into the neighboring gap to be measured. The refractive index of the prism is not limited also, and the prism can be a rectangular prism, triangular prism, semi-spherical lens, or semi-cylindrical lens, etc. Besides directly plating the metal thin film on the bottom surface of the prism, a carrier plate plated with the metal thin film can be adhered to the prism by means of a matching liquid having a refractive index similar to that of the prism. In addition to the prism coupling, the method of light coupling also can use conventional coupling modes such as grating coupling and optical waveguide coupling.

The light detection unit converts the reflected light signals into electrical signals, and essentially comprises photoelectric conversion devices such as light sensing diodes, photomultiplier tubes, light amplifying diodes, CCD sensors, CMOS sensors or the like. In order to reduce the accompanying noise when the reflected light enters the light detection unit, optical components such as lenses, filters, and polarizers can be disposed at the entrance of the light detection unit, which are regarded as a part of the light detection unit.

The output unit stores or converts the electrical signals transmitted from the light detection unit, and transmits output signals to a display device (e.g., an oscilloscope, a monitor, or a printer), a storage element (e.g., a memory, a disk, a hard disk, a memory card), or the control element for precise distance control. The distance of the small gap or displacement shift can be acquired by data simulation of the output signals or comparing the output signals with the LUT.

The relative subject is distanced from the surface plated with the metal thin film of the light coupling unit by a small gap, i.e., the gap to be measured described in the light coupling unit. The surface of the relative subject can be a single medium material, or a thin film coated with other materials (e.g., oxide, nitride, halide, or other metal and compound thereof), and the relative subject can be a local area of a surface of a large subject. The relative subject can be of transparent, semi-transparent, or opaque material. In cases using a transparent material, the light sensing element can be disposed at the light transmitting position, and the size of the small gap can be acquired by calculating the change of SPR based on the change of the transmitted light signals. The state of substance filled in the gap to be measured can be vacuum state, gas state (filled with air, gases of any type and concentration), liquid state (filled with water solution, alcohol solution, or other liquids), colloid (resin, adhesive, etc.), or resilient solid media (rubber, micro springs, etc.), which will not affect the generation of the surface plasmon wave on the light coupling element.

As to the steps of the measuring method using SPR of the present invention, once an incident light source is selected, the light has to be modulated to be an incident light beam containing TM wave. When the incident light beam containing TM wave is guided to be incident on the light coupling unit, the surface plasmon wave is activated on the surface of the metal thin film. When the specific resonance condition is met through certain adjustment, SPR occurs. Then, the reflected light signals or the transmitted light signals are selectively measured. Because the electric field intensity of the surface plasmon wave significantly changes along with the change of the gap width within twice the penetration depth, the condition of SPR is sensitive to the size of the small gap when the gap is less than or equal to twice the penetration depth. Accordingly, the distance of the small gap can be obtained by measuring the variation of the signals in comparison with the data simulation results or the LUT mentioned above, and the relative position of the gap can be further calculated.

Likewise, the measuring apparatus described above can also be used to measure small displacement shifts, and the details of the measuring steps are identical to those of the method of measuring gap width. Nevertheless, the distance of the displacement shift is obtained by comparing the difference between the sizes of gap before and after the relative displacement shift. According to the characteristic that the SPR is sensitive to slight displacement shifts, a method of measuring slight displacement shifts with high resolution can be obtained.

The SPR apparatus and method of the present invention can use all of the three incident light coupling modes, including grating coupling, optical waveguide coupling, and prism coupling.

In addition, the gap width, displacement shift, or relative position between two subjects can also be measured as described above if the image signals of the reflected light or the transmitted light are acquired by a CCD or CMOS sensor, and then are converted to relative values by image numerical analysis. Moreover, as the relative gaps of small local areas between two subjects are different, images acquired by the CCD or CMOS sensor can have comparative change of the contrast in the SPR images, which can be used to measure the flatness or change of the shape of the surface of the relative subject.

The present invention can measure gaps with the widths of less than 100 nm or even 10 nm, and can be used for many applications. For example, it can be applied for a servo control system of the pick-up head for near-field optical discs, and can sense and control the distance between the pick-up head and the optical disk at near-field distances so as to assure the correctness and reliability of reading and writing. The present invention can be applied in a sub-nanometer photolithography system to sense the proximity distance between a mask and a silicon wafer, so as to improve the reliability of the system. Also, the present invention can be applied in sensing and controlling the gap of liquid crystal layers for new-generation LCDs, in surface curve plotters, or the like. With the development of various nanometer techniques, various micro-products have been developed. The present invention is applicable to the sensing units for sensing gap size and displacement shift or for precise distance control of the products and techniques, so it will have extensive applications in the future.

With the progress of science and technology, techniques to improve the resolution or sensitivity of the measuring method using SPR together with the “common-path super heterodyne” or “phase compensation feedback” have been disclosed in many documents. In addition, researchers have also developed a method to detect the SPR effect by measuring the change of transmitted light signals penetrating through the metal thin film. However, no matter how complicated the apparatus is or what auxiliary methods are added, the apparatus and method to acquire gap width of nanometer-scale, displacement shift, and relative position between two subjects is still included in the technical scope of the present invention as long as the resonance condition is met through the coupling and matching of the wave vector of the incident light and the wave vector of the surface plasmon wave and using the characteristic of changing greatly when the interface condition changes slightly.

### BRIEF DESCRIPTION OF THE SEVERAL VIEWS OF THE DRAWINGS

FIG. 1 shows a graph illustration of a known SPR curve diagram.

FIG. 2(a) is a schematic view of measuring a gap of Otto configuration.

FIG. 2(b) is another schematic view for controlling a gap distance of Otto configuration.

FIG. 3(a) is a graph illustration of a curve of reflectivity of the conventional K.R. configuration of a three-layer architecture obtained by program simulation in accordance with the present invention.

FIG. 3(b) is another graph illustration of a curve of reflectivity obtained by simulation when the K.R. configuration of a three-layer architecture approaches a relative subject in accordance with the present invention.

FIG. 4 shows a schematic view of an SPR measuring apparatus in accordance with an embodiment of the present invention.

FIG. 5 is a schematic view of main components of an SPR measuring apparatus in accordance with an embodiment of the present invention.

FIG. 6 is a graph illustration of the reflectivity curves of SPR corresponding to different gap widths in accordance with an embodiment of the present invention.

### DETAILED DESCRIPTION OF THE INVENTION

The corresponding relations of the reflective coefficients and various multi-layer interfaces can be calculated according to the optical Fresnel reflection theorem. The equation of the change of the reflectivity is expressed by:

$$\begin{matrix}R = {\vert {r}_{0123} \vert}^{2} = {\vert \frac{{r}_{01} + {r}_{123} exp ( j 2 {k}_{z 1} {d}_{1} )}{1 + {r}_{01} {r}_{123} exp ( j 2 {k}_{z 1} {d}_{1} )} \vert}^{2} & ( 4 ) \\ {r}_{123} = \frac{{r}_{12} + {r}_{23} exp ( j 2 {k}_{z2} {d}_{2} )}{1 + {r}_{12} {r}_{23} exp ( j 2 {k}_{z2} {d}_{2} )} & ( 5 ) \\ {r}_{nm} = ( {ɛ}_{m} {k}_{zn} - {ɛ}_{n} {k}_{zm} ) / ( {ɛ}_{m} {k}_{zn} + {ɛ}_{n} {k}_{zm} ) & ( 6 ) \\ {k}_{zm} = \sqrt{{k}_{x}^{2} - {ɛ}_{m} {k}_{inc}^{2}} & ( 7 )\end{matrix}$$

where the subscript 0 represents the prism layer; 1 represents a metal layer; 2 represents the gap layer; 3 represents the relative subject to be measured, R is the reflectivity, r₀₁₂₃ is the reflective coefficient of the combination of the four layers, r₁₂₃ is the reflective coefficient of the combination of the three layers, rₙₘ is the reflective coefficient of any two neighboring layers n, m, εₘ is the dielectric coefficient of the m layer, dₘ is the thickness of the m layer, k_{zm} is the z component of the wave vector of the m layer, k_{inc} is the wave vector of the incident light, and kₓ is the x component of the wave vector of the incident light.

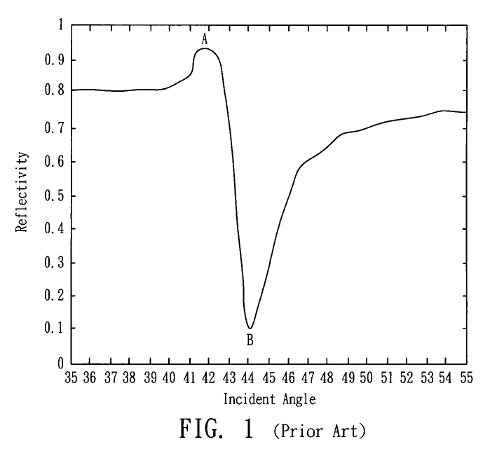

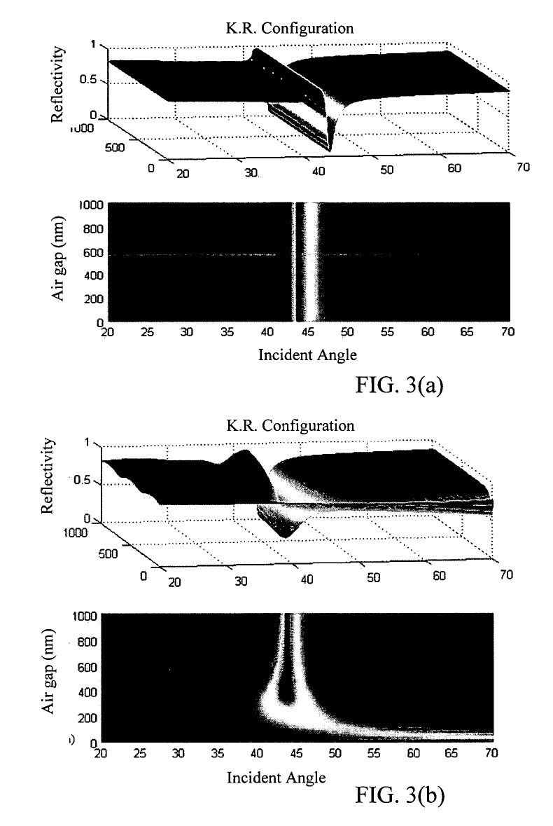

The present invention is based on the K.R. configuration, and develops a complete three-dimensional simulation program from Equations (4)-(7). The result of the simulation is as shown in FIG. 3(a). FIG. 3(a) shows the corresponding relation between the reflectivity and the incident angle of the three-layer architecture (prism/metal/air) of the conventional K.R. configuration, wherein the change of the curve is similar to that shown in FIG. 1 illustrating prior art. The reflectivity enters the total reflection region with the increase of the incident angle, and at this time the reflectivity is the highest. Then, as the requirements of SPR are met, the energy of the incident light is coupled to the surface plasmon wave, and the reflectivity dramatically decreases to the lowest. The incident angle at this time is the so-called resonance angle. After passing this point, the resonance condition gradually disappears, the reflectivity arises again.

Referring to FIG. 3(b), the same three-dimensional simulation program is used to simulate the change of the reflectivity when a relative subject gradually approaches the K.R. configuration of a three-layer architecture, i.e., the relative subject gradually approaches the prism. When the gap is gradually reduced to twice the penetration depth of the surface plasmon wave, which is about half the wavelength of the incident light, the position of the resonance angle of the reflectivity curve drifts toward a greater angle when the gap narrows. The present invention uses the characteristic that the change of the resonance curve is very sensitive when a small gap between the prism and the subject to be measured is less than or equal to twice the penetration depth of the surface plasmon wave to measure the small gap, relative displacement shift, or relative position of nanometer scale, and further develops the related measuring apparatus.

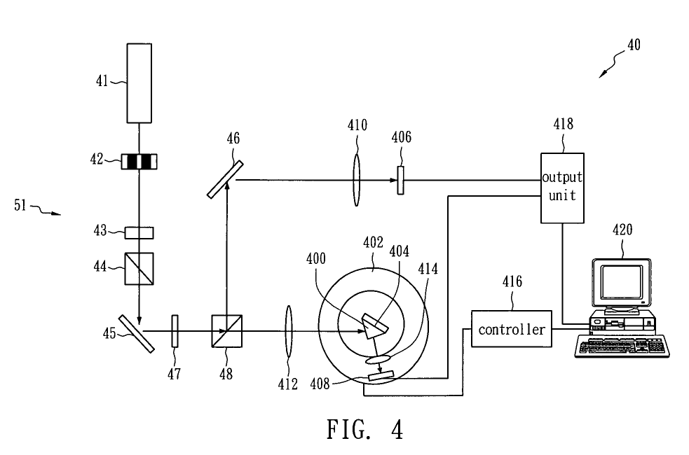

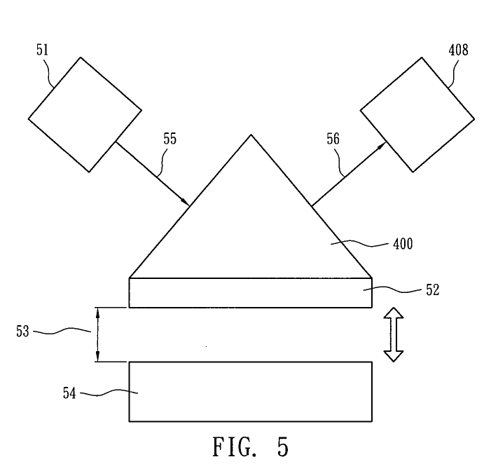

FIG. 4 illustrates a measuring apparatus using SPR of the present invention. A measuring apparatus 40 using SPR mainly comprises a lighting assembly 51, a light coupling unit 400, a light detection unit 408, and an output unit 418. In this embodiment, the light coupling element 400 is a prism, and a gap exists between the prism 400 and a relative subject (which is not shown in FIG. 4, and is illustrated in detail in FIG. 5). The measuring apparatus 40 is used to measure the size of the gap, and relevant displacement shift and the relative position can be measured thereby. The output unit 418 is a display device, a storage device, or a control device.

In this embodiment, the light assembly 51 includes a light source 41, a chopper 42, a half-wave delay device 43, a polarization beam splitter (PBS) 44, a polarizer 47, and a beam splitter (BS) 48. The light source 41 uses a linear polarized Helium-Neon laser light source with a wavelength of 632.8 nm. The light beam generated by the light source 41 is converted by the chopper 42 from a continuous wave laser light into a pulse laser light, and the polarization angle of the light beam is converted into a TM mode light beam by the half-wave delay device 43 and the polarization beam splitter 44.

The TM mode light beam is split into two light beams by the beam splitter 48, wherein one beam serves as a reference light beam, and the other beam is incident into the prism 400 for calculating the change of the reflectivity. Sequentially, a movement device 404 is used to adjust the gap width between the prism 400 and the relative subject. When SPR occurs, angles scribed on a rotating device 402 are used to record different positions of the resonance angle. The rotating device 402 and the movement device 404 are driven by a motor controlled by a controller 416. The two light beams are respectively measured by the light detection unit 408 and another light detection unit 406, and are displayed on the output unit 418. The output unit 418 is an oscilloscope in this embodiment. Then, the related reflectivity data are input into a computer 420 for analysis.

In this embodiment, the addition of the chopper 42, the polarizer 47, the beam splitter 48, lenses 410, 412 and 414, reflecting mirrors 45, 46, the rotating device 402, the computer 420 and components related to the reference light beam is only to improve the convenience and accuracy of the measurement, and can be appropriately modified or replaced as desired. The modifications will not affect the completeness and the utility of the present invention.

FIG. 5 illustrates the details of the structure of the prism 400 and related components. The surface of the prism 400 facing a carrier plate 54 is coated with a metal thin film 52 (a gold thin layer with a thickness of 40 nm in this embodiment), and a gap 53 is formed between the metal thin film 52 and the carrier plate 54. The TM mode beam 55 is generated by the lighting assembly 51, and injected into the prism 400 to generate SPR on the metal thin film 52. The signal of the reflected light 56 is detected by the light detection unit 408. The material of the carrier plate 54 can be glass, and the flat surface of the carrier plate 54 makes the reflected light 56 more even. The carrier plate 54 is disposed on the movement device 404 to move the carrier plate 54 in relation to the prism 400, so as to adjust the size of the gap. The gap 53 can be an air gap, and can be operated in vacuum environment, or can contain other gases, liquids or resilient medium solids; any of these can be applied in the present invention.

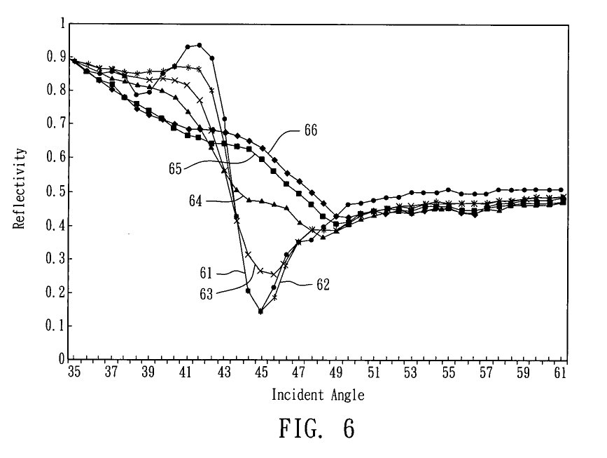

The carrier plate 54 is equivalent to the relative subject described above. When the gap 53 is less than or equal to twice the penetration depth of the TM mode light beam 55 (about half the wavelength of the beam 55), e.g., the carrier plate 54 gradually approaches the prism 400, the intensity of the reflected light detected by the light detection unit 408 changes as shown in FIG. 6. Curves 61-66 are curves of the data detected when the gap 53 gradually narrows. The curve 61 is the phenomenon observed when the distance between the metal thin film 52 on the surface of the prism 400 and the carrier plate 54 (the relative subject) is greater than one half of the TM mode light beam 55; the position of the resonance angle is substantially equivalent to that of the conventional K.R. configuration of a three-layer architecture. The position of the angle is approximately 45 degrees, and the reflectivity is around 0.12. Curves 62-66 correspond to the gap 53 that decreases gradually, and at this time the resonance angle drifts toward greater angles, and the reflectivity gradually increases. For example, the resonance angle of Curve 66 drifts to around 49 degrees, and the reflectivity at the angle of 45 degrees increases to about 0.65. As the gap 53 continues to become smaller, the resonance angle increases accordingly and eventually disappears, i.e., no concave portion is shown on the curve.

When small relative displacement shift is generated between the carrier plate 54 (the relative subject) and the prism 400, the gap 53 changes, and the intensity of the reflected light 56 detected by the light detection unit 408 changes accordingly. Based on the same principle, by measuring the widths at two different positions of the gaps, and calculating the difference between the two widths, the small relative displacement shift of the carrier plate 54 (the relative subject) can be obtained.

As described above, the measuring method using SPR has several basic application methods, for example, the angular interrogation measurement, the wavelength interrogation measurement, the intensity interrogation measurement, the phase interrogation measurement, or any combination thereof. Though only the angular interrogation measurement is exemplified as an embodiment of the measuring apparatus and method of the present invention, those skilled in the art can obtain the same results using other manners described above. Therefore, the measuring apparatus and method using the different signal measurement methods as described above will be a part of the present invention.

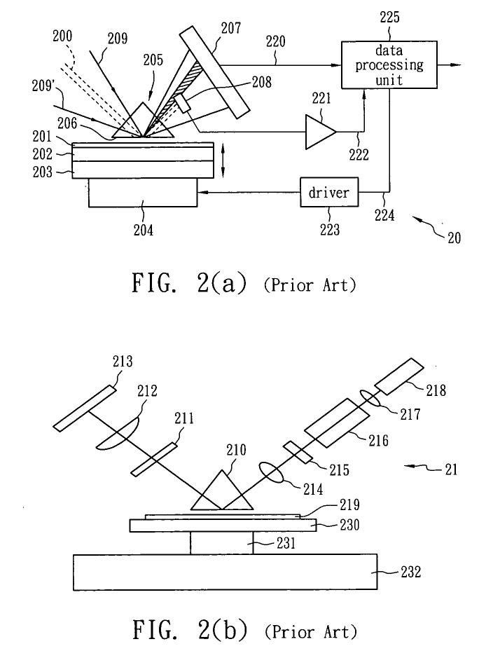

Compared to the conventional SPR apparatus shown in FIG. 2(a), the present invention requires only a single light source and a single light detector to detect a small gap, a displacement shift, or a relative position, and does not need a complicated structure. Furthermore, the conventional art of FIG. 2(b) uses the Otto configuration to generate SPR, and is not used to measure the gap between two subjects, which is different from the present invention that applies SPR of the K.R. configuration to measure the gap and relative displacement shift between two subjects.

The above-described embodiments of the present invention are intended to be illustrative only. Numerous alternative embodiments may be devised by those skilled in the art without departing from the scope of the following claims.

We claim:

1. A measuring apparatus using surface plasmon resonance, comprising:
a lighting assembly generating a light beam containing a transverse magnetic (TM) mode component;
a light coupling unit having a surface with a metal thin film thereon for activation by the light beam to generate a surface plasmon resonance wave;
a relative subject distanced from the surface of the metal thin film by a gap, width of the gap being less than or equal to twice a penetration depth of the surface plasmon resonance wave;
a light detection unit detecting a reflected light signal or a transmitted light signal of the light beam on the surface of the metal thin film, and converting the reflected light signal or the transmitted light signal into an electrical signal; and
an output unit converting the electrical signal into an output signal so as to obtain a geometrical value between the light coupling unit and the relative subject.

2. The measuring apparatus using surface plasmon resonance of claim 1, wherein said geometrical value is width of said gap, a relative displacement shift of the light coupling unit and the relative subject, a relative position of the light coupling unit and the relative subject, or a surface flatness of the relative subject.

3. The measuring apparatus using surface plasmon resonance of claim 1, wherein the gap is less than or equal to half the wavelength of the light beam.

4. The measuring apparatus using surface plasmon resonance of claim 1, wherein said lighting assembly has a light source for generating the light beam, said light source being comprised of a laser light, a tungsten filament lamp, a mercury lamp, an LED, or a synchronic radiating light.

5. The measuring apparatus using surface plasmon resonance of claim 1, wherein the wavelength of the light beam is in a frequency band of infrared light, visible light, or ultraviolet light.

6. The measuring apparatus using surface plasmon resonance of claim 1, wherein the light beam containing the TM mode component is modulated by an optical lens group or a polarizer.

7. The measuring apparatus using surface plasmon resonance of claim 1, wherein the light coupling unit generates the surface plasmon resonance wave by prism coupling, grating coupling, or optical waveguide coupling.

8. The measuring apparatus using surface plasmon resonance of claim 1, wherein the metal thin film is comprised of a single layer of gold or silver, or composite metal.

9. The measuring apparatus using surface plasmon resonance of claim 1, wherein the metal thin film is comprised of a plurality of layers of gold or silver, composite metal, or composite material.

10. The measuring apparatus using surface plasmon resonance of claim 1, wherein the light detection unit is a light sensing diode, a photomultiplier tube, a light amplifying diode, a CCD sensor, or a CMOS sensor.

11. The measuring apparatus using surface plasmon resonance of claim 1, wherein the output unit is a display device, a storage device or a control device, and the geometrical value is acquired based on the output signal in comparison with data simulation results, a look-up table of experiment values, or image numerical analysis.

12. The measuring apparatus using surface plasmon resonance of claim 1, wherein the surface of the relative subject is a single medium material or is coated with a material layer.

13. The measuring apparatus using surface plasmon resonance of claim 1, wherein the relative subject is a local area on a surface of a large subject.

14. The measuring apparatus using surface plasmon resonance of claim 1, wherein the relative subject is comprised of transparent, semi-transparent, or opaque material.

15. The measuring apparatus using surface plasmon resonance of claim 1, wherein the gap is under vacuum, or filled with gas, liquid, or resilient solid medium.

16. The measuring apparatus using surface plasmon resonance of claim 1, wherein the gap is filled with air, water solution, alcohol solution, resin, adhesive, colloid, rubber, or a micro spring.

17. The measuring apparatus using surface plasmon resonance of claim 1, wherein the geometrical value is obtained by an angular interrogation measurement, a wavelength interrogation measurement, an intensity interrogation measurement, a phase interrogation measurement, or a combination thereof.

18. The measuring apparatus using surface plasmon resonance of claim 7, wherein the prism coupling uses a rectangular prism, a triangular prism, a semi-spherical prism, or a semi-cylindrical prism.

19. The measuring apparatus using surface plasmon resonance of claim 1, wherein the light coupling unit is formed by plating the metal thin film on a prism, a grating, or an optical waveguide.

20. The measuring apparatus using surface plasmon resonance of claim 1, wherein the light coupling unit is formed by adhering a carrier plate plated with the metal thin film onto a prism, a grating, or an optical waveguide with a refractive index matching liquid.

21. The measuring apparatus using surface plasmon resonance of claim 1, wherein the relative subject is transparent or a semi-transparent, and the geometrical value is acquired according to the variation of the transmitted light signal of the light beam on the surface of the metal thin film.

22. A measuring method using surface plasmon resonance for measuring a geometrical value between two subjects, comprising the steps of:
providing a light beam containing a TM mode component;
generating a surface plasmon resonance wave on a surface of one of the two subjects by the light beam; and
measuring a reflected light signal or a transmitted light signal of the light beam and obtaining a geometrical value from variation of the reflected light signal or the transmitted light signal according to a phenomenon that an SPR effect is sensitive to size change of a gap between the two subjects distance if the gap is less than or equal to twice the penetration depth of the surface plasmon resonance wave.

23. The measuring method using surface plasmon resonance of claim 22, wherein the geometrical value is a width of the gap, a flatness of the surface of the one of the two subjects, a relative displacement shift or a relative position of the two subjects.

24. The measuring method using surface plasmon resonance of claim 22, wherein the gap is less than or equal to half the wavelength of the light beam.

25. The measuring method using surface plasmon resonance of claim 22, wherein the surface plasmon resonance wave is generated by prism coupling, grating coupling, or optical waveguide coupling.

26. The measuring method using surface plasmon resonance of claim 22, wherein the reflected light signal or the transmitted light signal of the light beam is converted into an electrical signal, and the geometrical value is acquired based on the electrical signal in comparison with the data simulation results or a look-up table of experiment values, or image numerical analysis.

27. The measuring method using surface plasmon resonance of claim 22, wherein the geometrical value is obtained by an angular interrogation measurement, a wavelength interrogation measurement, an intensity interrogation measurement, a phase interrogation measurement, or a combination thereof.

28. The measuring method using surface plasmon resonance of claim 22, wherein the one of the two subjects is a prism having a surface with a metal thin film, and the surface plasmon resonance wave is generated on the surface of the metal thin film.
